(19) United States
(12) Patent Application Publication
(10) Pub. No.: US 2025/0102974 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventors: Kenji OMORI, Kanagawa (JP); Hideaki OHARA, Kanagawa (JP); Ryohei YOSHIKAWA, Kanagawa (JP)

(73) Assignee: FUJIFILM Business Innovation Corp., Tokyo (JP)

(21) Appl. No.: 18/641,862

(22) Filed: Apr. 22, 2024

(30) Foreign Application Priority Data
Sep. 27, 2023 (JP) 2023-166028

(51) Int. Cl. G03G 15/20; C10M 107/50

(52) U.S. Cl. CPC G03G 15/2028; C10M 107/50; G03G 15/2025; G03G 15/206; G03G 15/2064; C10M 2229/025

(57) ABSTRACT

A fixing device includes: a first rotatable member; a second rotatable member disposed in contact with first rotatable member; a pressing member that is disposed along an inner circumferential surface of second rotatable member and presses the inner circumferential surface of the second rotatable member such that the second rotatable member is pressed against the first rotatable member; a sliding member interposed between an inner circumferential surface of second rotatable member and the pressing member; and a lubricant interposed between the inner circumferential surface of the second rotatable member and the sliding member. The inner circumferential surface of the second rotatable member contains a resin having a siloxane group and a conducting material treated with siloxane. A sliding surface of sliding member contains a resin having a siloxane group and a conducting material treated with siloxane. The lubricant contains an oil having a siloxane group in a main chain.

### CROSS-REFERENCE TO RELATED APPLICATIONS

This application is based on and claims priority under 35 USC 119 from Japanese Patent Application No. 2023-166028 filed Sep. 27, 2023.

### BACKGROUND

### (i) Technical Field

The present disclosure relates to a fixing device and an image forming apparatus.

### (ii) Related Art

For example, Japanese Unexamined Patent Application Publication No. 2021-124559 discloses a “belt including a resin layer containing a polyimide and a siloxane-modified resin and disposed at least as an outermost layer configured to slide along a sliding member, wherein the molar ratio of the siloxane structure in the siloxane-modified resin is 20% by mole or more.”

Japanese Unexamined Patent Application Publication No. 11-219036 discloses a “transfer member used for an image forming method including transferring a toner image formed on an electrostatic latent image carrier onto the transfer member, heating and pressurizing the transfer member on which a recording medium is placed, cooling the transfer member, and separating the recording medium from the transfer member to thereby transfer and fix the toner image to the recording medium, wherein the transfer member includes a rubber layer having a uniform thickness and a siloxane-modified polyimide layer that are disposed in this order on a substrate.”

Japanese Patent No. 5147998 discloses a “multilayer tubular endless film including a surface layer, an elastic layer, and a base layer, wherein all the layers are seamless, wherein the surface layer is formed by centrifugal forming, wherein the material of the surface layer is at least one selected from the group consisting of fluorocarbon rubbers, fluorocarbon resins, siloxane-modified polyimides, and urethane rubbers, wherein the surface layer has a surface roughness (Rz) of 0.25 to 1.5 μm, wherein the base layer is formed by centrifugal forming, and wherein the material of the base layer is a polyimide or a polyamide-imide.”

### SUMMARY

One previously known fixing device includes: a first rotatable member; a second rotatable member disposed in contact with the first rotatable member, a pressing member that is disposed along an inner circumferential surface of the second rotatable member and presses the inner circumferential surface of the second rotatable member such that the second rotatable member is pressed against the first rotatable member; a sliding member interposed between the inner circumferential surface of the second rotatable member and the pressing member; and a lubricant interposed between the inner circumferential surface of the second rotatable member and the sliding member (this fixing device may be hereinafter referred to also as a specific fixing device).

Aspects of non-limiting embodiments of the present disclosure relate to a fixing device having both better slidability and a higher charge suppression ability than a specific fixing device in which the inner circumferential surface of the second rotatable member is formed only of a resin having no siloxane group (e.g., a polyimide resin) and a specific fixing device in which the sliding surface of the sliding member is formed only of a resin having no siloxane group (e.g., a fluorocarbon resin).

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including: a first rotatable member; a second rotatable member disposed in contact with the first rotatable member; a pressing member that is disposed along an inner circumferential surface of the second rotatable member and presses the inner circumferential surface of the second rotatable member such that the second rotatable member is pressed against the first rotatable member; a sliding member interposed between the inner circumferential surface of the second rotatable member and the pressing member; and a lubricant interposed between the inner circumferential surface of the second rotatable member and the sliding member, wherein the inner circumferential surface of the second rotatable member contains a resin having a siloxane group and a conducting material treated with siloxane, wherein a sliding surface of the sliding member contains a resin having a siloxane group and a conducting material treated with siloxane, and wherein the lubricant contains an oil having a siloxane group in a main chain.

### BRIEF DESCRIPTION OF THE DRAWINGS

An exemplary embodiment of the present disclosure will be described in detail based on the following figures, wherein:

FIG. 1 is a schematic illustration showing an example of an image forming apparatus according to an exemplary embodiment; and

FIG. 2 is a schematic illustration showing an example of a fixing device according to the exemplary embodiment.

### DETAILED DESCRIPTION

An A exemplary embodiment of the present disclosure will be described below. The following description and Examples are illustrative of the exemplary embodiment and are not intended to limit the scope of the present disclosure.

In a set of numerical ranges expressed in a stepwise manner in the present specification, the upper or lower limit in one numerical range may be replaced with the upper or lower limit in another numerical range in the set of numerical ranges. Moreover, in a numerical range described in the present specification, the upper or lower limit in the numerical range may be replaced with a value indicated in an Example.

Any component may contain a plurality of materials corresponding to the component.

When reference is made to the amount of a component in a composition, if the composition contains a plurality of materials corresponding to the component, the amount means the total amount of the plurality of materials in the composition, unless otherwise specified.

When the exemplary embodiment is described with reference to the drawings, components having substantially the same function are denoted by the same symbol throughout all the drawings, and their redundant description may be omitted.

### <Fixing Device/Image Forming Apparatus>

A fixing device according to the exemplary embodiment is a specific fixing device including: a first rotatable member; a second rotatable member disposed in contact with the first rotatable member; a pressing member that is disposed along the inner circumferential surface of the second rotatable member and presses the inner circumferential surface of the second rotatable member such that the second rotatable member is pressed against the first rotatable member; a sliding member interposed between the inner circumferential surface of the second rotatable member and the pressing member; and a lubricant interposed between the inner circumferential surface of the second rotatable member and the sliding member.

The inner circumferential surface of the second rotatable member contains a resin having a siloxane group and a conducting material treated with siloxane.

The sliding surface of the sliding member contains a resin having a siloxane group and a conducting material treated with siloxane.

The lubricant contains an oil having a siloxane group in a main chain.

An image forming apparatus according to the exemplary embodiment includes:
an image holding member;
a latent image forming device that forms a latent image on a surface of the image holding member;
a developing device that develops the latent image using a developer to form a toner image;
a transfer device that transfers the developed toner image onto a recording medium; and
a fixing device that fixes the toner image to the recording medium.

The fixing device according to the exemplary embodiment is applied to the image forming apparatus according to the exemplary embodiment.

The fixing device and the image forming apparatus in the exemplary embodiment that have the structures described above have good slidability and a high charge suppression ability. The reason for this may be as follows.

To form an image using a conventional electrophotographic image forming apparatus such as a printer, a copier, or a facsimile, first, a toner image is transferred onto a recording medium such as a recording paper sheet. Then the recording medium with the toner image transferred thereonto is heated and pressurized in a fixing device to thereby fix the toner image to the surface of the recording medium.

Various types of fixing devices have been proposed. One of them is the specific fixing device described above.

In the specific fixing device, as the degree of friction between the second rotatable member (e.g., a fixing belt) and the sliding member increases, the ability to transport a recording medium deteriorates, and the occurrence of paper wrinkling tends to increase. In addition, as the degree of triboelectrification due to rotation increases, an electrostatic attractive force acts on the toner on the recording medium, and electrostatic offset tends to occur, which is a phenomenon in which an unfixed transferred toner image is disturbed near the inlet of a fixing nip part.

However, in the fixing device and the image forming apparatus according to the exemplary embodiment, the inner circumferential surface of the second rotatable member contains a resin having a siloxane group and a conducting material treated with siloxane. The sliding surface of the sliding member contains a resin having a siloxane group and a conducting material treated with siloxane. The lubricant contains an oil having a siloxane group in a main chain. Since the inner circumferential surface of the second rotatable member, the sliding surface of the sliding member, and the lubricant contain the respective materials each having a siloxane bond as described above, they are highly compatible with each other and conform well to each other. Therefore, the lubricant interposed between the second rotatable member and the sliding member is prevented from being discharged and exhausted, and the good slidability is easily maintained.

On the inner circumferential surface of the second rotatable member, the resin having a siloxane group and the conducting material treated with siloxane are well mixed with each other, so that the conducting material is prevented from coming off from the inner circumferential surface of the second rotatable member because of sliding. Therefore, a reduction in the charge suppression ability is prevented. On the sliding surface of the sliding member, as well as on the inner circumferential surface of the second rotatable member, the resin having a siloxane group and the conducting material treated with siloxane are well mixed with each other, so that the conducting material is prevented from coming off from the sliding surface of the sliding member because of sliding. Therefore, a reduction in the charge suppression ability is further prevented.

An example of the image forming apparatus according to the exemplary embodiment will be described with reference to the drawings.

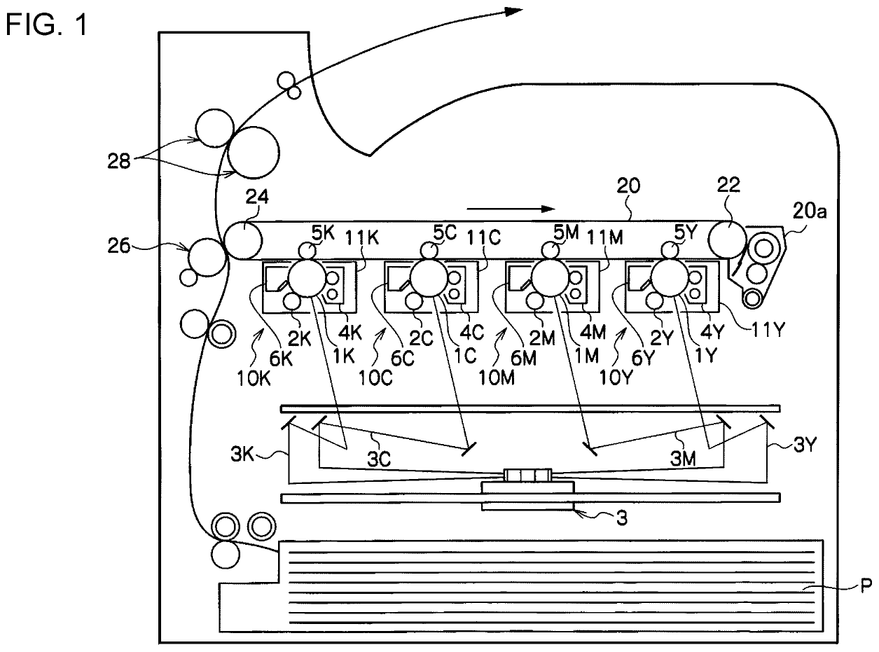

FIG. 1 is a schematic illustration showing an example of the image forming apparatus according to the exemplary embodiment.

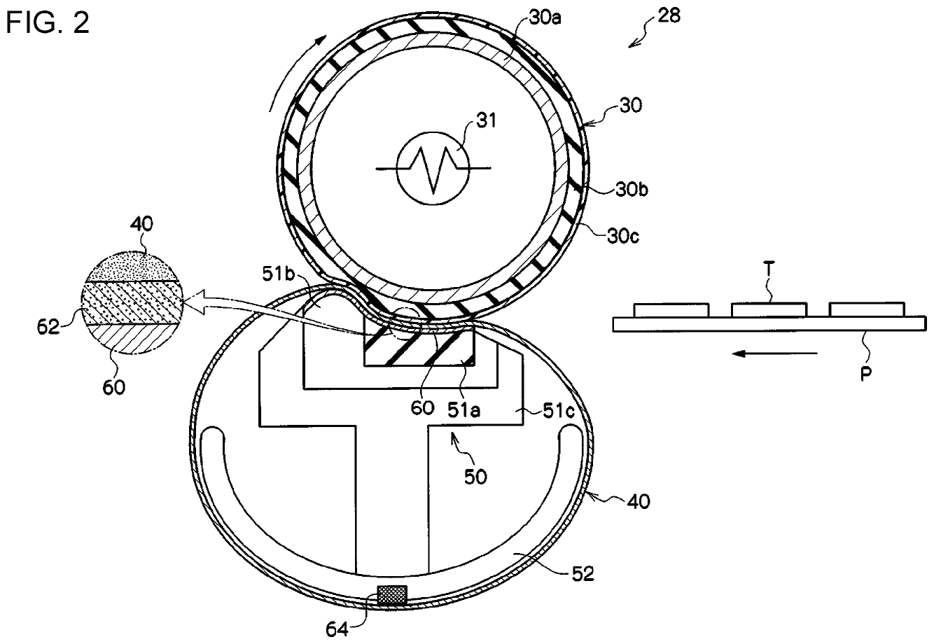

FIG. 2 is a schematic illustration showing an example of the fixing device according to the exemplary embodiment.

### (Structure of Image Forming Apparatus)

As shown in FIG. 1, the image forming apparatus 100 according to the exemplary embodiment includes first to fourth electrophotographic process cartridges 10Y, 10M, 10C, and 10K (examples of an image forming unit) that output yellow (Y), magenta (M), cyan (C), and black (K) images, respectively, based on color-separated image data. These process cartridges 10Y, 10M, 10C, and 10K are arranged so as to be spaced apart from each other along the outer circumferential surface of an intermediate transfer belt 20. These process cartridges 10Y, 10M, 10C, and 10K are detachably attached to the image forming apparatus.

The intermediate transfer belt 20 serving as an intermediate transfer body is disposed above (in FIG. 1) the process cartridges 10Y, 10M, 10C, and 10K such that the outer circumferential surface of the intermediate transfer belt 20 faces the process cartridges. The intermediate transfer belt 20 is wound around a driving roller 22 and a support roller 24 that are disposed so as to be spaced apart from each other, the support roller 24 being in contact with the inner circumferential surface of the intermediate transfer belt 20. The intermediate transfer belt 20 is tensioned between these rollers and runs endlessly in a direction from the first process cartridge 10Y toward the fourth process cartridge 10K.

The support roller 24 is pressed by an unillustrated elastic member such as a spring in a direction away from the driving roller 22, and a tension is thereby applied to the intermediate transfer belt 20 wound between these rollers. An intermediate transfer body cleaning device 20a is disposed on the outer circumferential surface of the intermediate transfer belt 20 so as to be opposed to the driving roller 22.

Since the first to fourth process cartridges 10Y, 10M, 10C, and 10K have substantially the same structure, the first process cartridge 10Y that is disposed on an upstream side in the running direction of the intermediate transfer belt and forms a yellow image will be described as a representative. The same portions of the second to fourth process cartridges 10M, 10C, and 10K as those in the first process cartridge 10Y are designated by the same reference symbols with the letter yellow (Y) replaced with magenta (M), cyan (C), and black (K), and their description will be omitted.

The first process cartridge 10Y includes a photoconductor 1Y serving as the image holding member. A charging roller (an example of a charging device) 2Y that charges the surface of the photoconductor 1Y to a prescribed potential, a developing device 4Y that supplies a charged toner contained in a developer to an electrostatic latent image to develop the electrostatic latent image, and a photoconductor cleaning device 6Y that removes the toner remaining on the surface of the photoconductor 1Y after first transfer are sequentially disposed around the photoconductor 1Y. These are disposed integrally in a housing 11Y (casing). In the second to fourth process cartridges 10M to 10K also, their components are disposed integrally in respective housings 11M to 11K (casings).

A first transfer roller 5Y (an example of a first transfer device) that transfers the developed toner image onto the intermediate transfer belt 20 and an exposure device 3 that irradiates the charged surface with a laser beam 3Y according to a color-separated image signal to form an electrostatic latent image are disposed together with the first process cartridge 10Y to thereby form an image forming unit.

The charging roller 2Y and the exposure device 3 correspond to an example of the latent image forming device.

The first transfer roller 5Y is disposed on the inner side of the intermediate transfer belt 20 and located at a position opposed to the photoconductor 1Y. Bias power sources (not shown) that apply first transfer biases are connected to the first transfer rollers 5Y, 5M, 5C, and 5K. Each bias power source is controlled by an unillustrated controller and changes the transfer bias applied to the corresponding first transfer roller.

### (Structure of Fixing Device)

As shown in FIG. 2, the fixing device 28 includes a heating roller 30 (an example of the first rotatable member) and a pressing belt 40 (an example of the second rotatable member), and the heating roller 30 and the pressing belt 40 are disposed so as to be opposed to each other. The pressing belt 40 is pressed against the heating roller 30 by a pressing pad 50 (an example of the pressing member) disposed on the inner circumferential side of the pressing belt 40 and driven by a driving force received from the heating roller 30 along a belt running guide 52 while a contact portion is formed between the pressing belt 40 and the heating roller 30 that are in pressure contact with each other.

A sliding sheet 60 (an example of the sliding member) is interposed between the pressing belt 40 and the pressing pad 50. A lubricant 62 (an example of the lubricant) is interposed between the sliding sheet 60 and the inner circumferential surface of the pressing belt 40. The lubricant 62 is supplied to the inner circumferential surface of the pressing belt 40 from, for example, a lubricant supply member 64 disposed in a part of the belt running guide 52 so as to be interposed between the sliding sheet 60 and the inner circumferential surface of the pressing belt 40.

In FIG. 2, T represents a toner image.

### —Heating Roller 30 (Example of First Rotatable Member)—

The heating roller 30 includes a hollow metal core 30a including a heat source 31 such as a halogen lamp disposed thereinside and further includes an elastic layer 30b and a release layer 30c that are formed in this order on the metal core 30a.

The metal core 30a is formed from a cylindrical body made of a metal such as aluminum or stainless steel. The elastic layer 30b is made of, for example, an HTV silicone rubber or a fluorocarbon rubber (having a JIS-A rubber hardness of about 45 degrees, the rubber hardness being measured using an A-type hardness meter of the spring type manufactured by Teclock Corporation under a load of 1,000 gf according to JIS K6301) and has a thickness of from about 2 mm to about 5 mm. The release layer 30c is made of, for example, a fluorocarbon rubber, a silicone rubber, or a fluorocarbon resin and has a thickness of 20 μm or more and 50 μm or less. Of course, these are not limitations, and well-known materials may be used.

The heating roller 30 serves as a fixing roller and is driven to rotate such that its peripheral speed is adjusted to, for example, 260 mm/see by an unillustrated driving source. The outer diameter of the heating roller 30 is generally, for example, from about 25 mm or more and about 80 mm or less.

The surface temperature of the heating roller 30 is detected by an unillustrated temperature sensor in contact with its surface and controlled to, for example, 175° C. by an unillustrated control circuit.

### —Pressing Belt 40 (Example of Second Rotatable Member)—

The pressing belt 40 is formed such that the inner circumferential surface contains a resin having a siloxane group and a conducting material treated with siloxane. The resin is a heat-resistant resin. The term “heat-resistant” means that the resin does not melt or decompose even when its temperature reaches the heating temperature (e.g., the fixing temperature) of the fixing device. The same applies to the following.

The pressing belt 40 includes a resin base layer that forms the inner circumferential surface and that contains the resin having a siloxane group and the conducting material treated with siloxane.

The pressing belt 40 may be a single layer body composed of the resin base layer forming the inner circumferential surface of the pressing belt 40, a layered body composed of the resin base layer forming the inner circumferential surface of the pressing belt 40, an elastic layer disposed on the resin base layer, and a release layer disposed on the elastic layer, or a layered body composed of the resin base layer forming the inner circumferential surface of the pressing belt 40 and a release layer disposed on the resin base layer.

The resin base layer is a layer containing the resin having a siloxane group and the conducting material treated with siloxane and may be a layer containing a resin, resin particles of the resin having a siloxane group, and the conducting material treated with siloxane.

The surface resistivity of the inner circumferential surface of the pressing belt 40 is preferably 1.0×10⁷ Ω/square or less, more preferably 1.0×10⁶ Ω/square or less, and still more preferably 5.0×10⁵ Ω/square or less.

When the surface resistivity of the inner circumferential surface is 1.0×10⁷ Ω/square or less, a higher charge suppression ability is obtained.

No particular limitation is imposed on the method for adjusting the surface resistivity of the inner circumferential surface within the above range. Examples of the method include a method in which the inner circumferential surface is formed so as to contain the resin, the resin particles of the resin having a siloxane group, and the conducting material treated with siloxane.

The surface resistivity of the inner circumferential surface is measured using the same method as that for measuring the surface resistivity of the sliding surface of the sliding sheet 60 described later.

Preferred modes of the resin having a siloxane group are the same as preferred modes of the resin having a siloxane group in the sliding member described later.

Preferred modes of the conducting material treated with siloxane are the same as preferred modes of the conducting material treated with siloxane in the sliding member described later.

The content of the conducting material with respect to 100 parts by mass of the resin included in the layer (i.e., the resin base layer) forming the inner circumferential surface of the second rotatable member (e.g., the pressing belt 40) may be 5 parts by mass or more, preferably 5 parts by mass or more and 50 parts by mass or less, more preferably 5 parts by mass or more and 40 parts by mass or less, and still more preferably 5 parts by mass or more and 30 parts by mass or less.

When the content of the conducting material is 5 parts by mass or more, appropriate electrical conductivity is imparted, and a higher charge suppression ability is obtained. Moreover, the compatibility between the inner circumferential surface of the second rotatable member, the sliding surface of the sliding member, and the lubricant tends to increase, and better slidability is obtained. When the content of the conducting material is 50 parts by mass or less, the second rotatable member is not embrittled, and the conducting material is easily prevented from coming off, so that a higher charge suppression ability is obtained.

Examples of the resin include polyimide resins, polyamide-imide resins, polyether ether ketone resins, polyphenylene sulfide resins, polyethersulfone resins, polysulfone resins, and polyphenylsulfone resins. One resin may be used alone, or a combination of two or more may be used.

In particular, the resin is preferably at least one selected from the group consisting of polyimide resins, polyamide-imide resins, polyether ether ketone resins, and polyphenylene sulfide resins and more preferably a polyimide resin. These resins (in particular polyimide resins) have high wear resistance and tend to be highly compatible with the lubricant. Therefore, better slidability and a higher charge suppression ability are obtained.

Examples of the polyimide resins include imidized products of polyamic acids (precursors of polyimide resins) that are polymers of tetracarboxylic dianhydrides and diamine compounds.

Examples of the polyimide resins include resins having a structural unit represented by the following general formula (I).

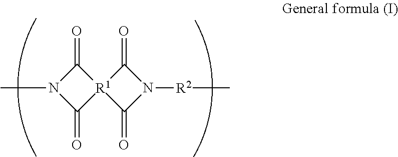

In general formula (I), R¹ represents a tetravalent organic group, and R² represents a divalent organic group.

Examples of the tetravalent organic group represented by R¹ include aromatic groups, aliphatic groups, alicyclic groups, combinations of aromatic and aliphatic groups, and substituted groups thereof. Specific examples of the tetravalent organic group include residues of tetracarboxylic dianhydrides described later.

Examples of the divalent organic group represented by R² include aromatic groups, aliphatic groups, alicyclic groups, combinations of aromatic and aliphatic groups, and substituted groups thereof. Specific examples of the divalent organic group include residues of diamine compounds described later.

Specific examples of the tetracarboxylic dianhydride used as a raw material of the polyimide resin include pyromellitic dianhydride, 3,3′,4,4′-benzophenonetetracarboxylic dianhydride, 3,3′,4,4′-biphenyltetracarboxylic dianhydride, 2,3,3′,4-biphenyltetracarboxylic dianhydride, 2,3,6,7-naphthalenetetracarboxylic dianhydride, 1,2,5,6-naphthalenetetracarboxylic dianhydride, 1,4,5,8-naphthalenetetracarboxylic dianhydride, 2,2′-bis(3,4-dicarboxyphenyl) sulfonic dianhydride, perylene-3,4,9,10-tetracarboxylic dianhydride, bis(3,4-dicarboxyphenyl) ether dianhydride, and ethylenetetracarboxylic dianhydride.

Specific examples of the diamine compound used as a raw material of the polyimide resin include 4,4′-diaminodiphenyl ether, 4,4′-diaminodiphenylmethane, 3,3′-diaminodiphenylmethane, 3,3′-dichlorobenzidine, 4,4′-diaminodiphenyl sulfide, 3,3′-diaminodiphenylsulfone, 1,5-diaminonaphthalene, m-phenylenediamine, p-phenylenediamine, 3,3′-dimethyl-4,4′-biphenyldiamine, benzidine, 3,3′-dimethylbenzidine, 3,3′-dimethoxybenzidine, 4,4′-diaminodiphenylsulfone, 4,4′-diaminodiphenylpropane, 2,4-bis(β-amino-tert-butyl) toluene, bis(p-β-amino-tert-butylphenyl) ether, bis(p-β-methyl-8-aminophenyl)benzene, bis-p-(1,1-dimethyl-5-amino-pentyl)benzene, 1-isopropyl-2,4-m-phenylenediamine, m-xylylenediamine, p-xylylenediamine, di(p-aminocyclohexyl) methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,17-diaminoeicosadecane, 1,4-diaminocyclohexane, 1,10-diamino-1,10-dimethyldecane, 12-diaminooctadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, and H₂N(CH₂)₃N(CH₃)₂(CH₂)₃NH₂.

Examples of the polyamide-imide resin include resins having a repeating unit including an imide bond and an amide bond.

More specific examples of the polyamide-imide resin include a polymer of a trivalent carboxylic acid compound (referred to also as a tricarboxylic acid) having an acid anhydride group with a diisocyanate compound or a diamine compound.

The tricarboxylic acid may be trimellitic anhydride or a derivative thereof. The tricarboxylic acid may be used in combination with a tetracarboxylic dianhydride, an aliphatic dicarboxylic acid, an aromatic dicarboxylic acid, etc.

Examples of the diisocyanate compound include 3,3′-dimethylbiphenyl-4,4′-diisocyanate, 2,2′-dimethylbiphenyl-4,4′-diisocyanate, biphenyl-4,4′-diisocyanate, biphenyl-3,3′-diisocyanate, biphenyl-3,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, and naphthalene-2,6-diisocyanate.

Examples of the diamine compound include compounds that have structures similar to the structures of the above isocyanates and have amino groups instead of the isocyanato groups.

The resin base layer may contain, in addition to the resin, additional components. Examples of the additional components include a conducting material, a filler for improving mechanical strength, an antioxidant for preventing thermal deterioration, a surfactant, and a heat resistant antioxidant.

In the above example, the first rotatable member is the heating roller, and the second rotatable member is the pressing belt. However, in another embodiment, the first rotatable member may be a pressing roller, and the second rotatable member may be a heating belt.

When the first rotatable member is a pressing roller, the structure of the pressing roller may be the same as the structure of the heating roller 30 described above.

When the second rotatable member is a heating belt, the structure of the heating belt may be the same as the structure of the pressing belt 40 described above.

In particular, when the second rotatable member is a heating belt, the heating belt may be a single layer body composed of a resin base layer forming the inner circumferential surface of the heating belt, a layered body including the resin base layer forming the inner circumferential surface of the heating belt, an elastic layer disposed on the resin base layer, and a release layer disposed on the elastic layer, a layered body including the resin base layer forming the inner circumferential surface of the heating belt and a release layer disposed on the resin base layer, or a layered body including the resin base layer forming the inner circumferential surface of the heating belt, a metal layer disposed on the resin base layer, an elastic layer disposed on the metal base layer, and a release layer disposed on the elastic layer.

The elastic layer will be described.

The elastic layer contains a heat resistant elastic material.

Examples of the heat resistant elastic material include silicone rubber and fluorocarbon rubber.

Examples of the silicone rubber include RTV (Room Temperature Vulcanizing) silicone rubber, HTV (High Temperature Vulcanizing) silicone rubber, and liquid silicone rubber. Specific examples include polydimethyl silicone rubber, methylvinyl silicone rubber, methylphenyl silicone rubber, and fluorosilicone rubber.

Examples of the fluorocarbon rubber include vinylidene fluoride-based rubber, tetrafluoroethylene/propylene-based rubber, tetrafluoroethylene/perfluoromethyl vinyl ether rubber, phosphazene-based rubber, and fluoropolyether.

The elastic layer may contain additional components. Examples of the additional components include a filler, a conducting material, a softener (such as a paraffin-based softener), a processing aid (such as stearic acid), an antioxidant (such as an amine-based antioxidant), a vulcanizing agent (sulfur, a metal oxide, a peroxide, etc.), and a functional filler (such as alumina).

The release layer will be described.

The release layer contains, for example, a heat resistant release material.

Examples of the heat resistant release material include fluorocarbon rubber, fluorocarbon resins, silicone resins, and polyimide resins.

In particular, the heat resistant release material may be a fluorocarbon resin. Specific examples of the fluorocarbon resin include: polytetrafluoroethylene (PTFE); and tetrafluoroethylene-perfluoroalkyl vinyl ether copolymers (PFA) such as tetrafluoroethylene-perfluoromethyl vinyl ether copolymers (MFA), tetrafluoroethylene-perfluoroethyl vinyl ether copolymers (EFA), and tetrafluoroethylene-perfluoropropyl vinyl ether copolymers. Other examples include tetrafluoroethylene-hexafluoropropylene copolymers (FEP), ethylene-tetrafluoroethylene copolymers (ETFE), polyvinylidene fluoride (PVDF), polychlorotrifluoroethylene (PCTFE), and polyvinyl fluoride (PVF).

Of these, polytetrafluoroethylene (PTFE) and tetrafluoroethylene-perfluoroalkyl vinyl ether copolymers (PFA) such as tetrafluoroethylene-perfluoromethyl vinyl ether copolymers (MFA) and tetrafluoroethylene-perfluoroethyl vinyl ether copolymers (EFA) may be used in terms of heat resistance, mechanical properties, etc.

The thickness of the release layer is set to preferably 5 μm to 100 μm and more preferably 10 μm to 30 μm.

### —Pressing Pad 50 (Example of Pressing Member)—

The pressing pad 50 includes two pressing members 51a and 51b having different hardnesses and arranged in the traveling direction of a recording medium P. The pressing member 51a on the recording medium P insertion side of the pressing pad 50 is formed from a rubber-like elastic member, and the pressing member 51b on the recording medium P discharge side is formed from a hard pressure-applying member such as a metal, so that the pressure in the contact region is higher on the recording medium P discharge side than on the recording medium P insertion side. The pressing members 51a and 51b are supported by a holder 51c, press the inner circumferential surface of the pressing belt 40 via the sliding sheet 60 (an example of the sliding member), and thus press the heating roller 30.

### —Sliding Sheet 60 (Example of Sliding Member)—

The sliding sheet 60 has the sliding surface containing a resin having a siloxane group and a conducting material treated with siloxane. Specifically, the sliding sheet 60 may be a resin sheet containing these components on the sliding surface side. When the sliding sheet 60 is a resin sheet containing the above components and slides on the inner circumferential surface of the second rotatable member formed such that the inner circumferential surface contains a resin having a siloxane group and a conducting material treated with siloxane, the sliding sheet 60 conforms well to the second rotatable member, and a higher charge suppression ability is obtained.

The surface resistivity of the sliding surface of the sliding sheet 60 is preferably 1.0×10⁷ Ω/square or less, more preferably 5.0×10⁶ Ω/square or less, and still more preferably 5.0×10⁵ Ω/square or less. When the surface resistivity of the sliding surface is 1×10⁷ Ω/square or less, a higher charge suppression ability is obtained.

No particular limitation is imposed on the method for adjusting the surface resistivity of the sliding surface within the above range. Examples of the method include a method in which the sliding surface is formed so as to contain a heat-resistant thermoplastic resin, resin particles of the resin having a siloxane group other than the heat-resistant thermoplastic resin, and the conducting material treated with siloxane.

The surface resistivity of the sliding surface is the surface resistivity when a voltage of 500 V is applied to the sliding surface of the sliding sheet 60 for 10 seconds and is determined using the following method. Specifically, the resistance meter used is a microammeter (R8430A manufactured by Advantest), and the probe used is a UR probe (manufactured by Mitsubishi Chemical Analytech Co., Ltd.). The measurement is performed using a voltage of 500 V, an application time of 10 seconds, and a load of 1 kgf at a total of 18 points, i.e., 6 points spaced circumferentially at regular intervals in each of 3 portions including a widthwise central portion and opposite widthwise edge portions, and then the average value is computed. In this case, the measurement is performed in an environment of a temperature of 22° C. and a humidity of 55% RH.

It is only necessary that the sliding sheet 60 be formed such that its sliding surface contains the resin having a siloxane group and the conducting material treated with siloxane, and the sliding surface may be formed from a resin base layer containing a heat-resistant thermoplastic resin, resin particles of the resin having a siloxane group other than the heat-resistant thermoplastic resin, and the conducting material treated with siloxane.

The sliding sheet 60 may by formed as a single layer composed only of the resin base layer forming the sliding surface or may be a layered body including the resin base layer and another layer disposed on the side opposite to the sliding surface of the resin base layer.

Examples of the heat resistant thermoplastic resin include polyether ether ketone resins, polyphenylene sulfide resins, polyetherimide resins, polyphenylsulfone resins, polyethersulfone resins, and polysulfone resins. Only one heat resistant thermoplastic resin may be used alone, or a combination of two or more may be used.

In particular, the heat-resistant thermoplastic resin is preferably at least one resin selected from the group consisting of polyether ether ketone resins, polyphenylene sulfide resins, polyetherimide resins, and polyphenylsulfone resins and more preferably at least one resin selected from the group consisting of polyether ether ketone resins and polyphenylene sulfide resins. These resins (in particular, polyether ether ketone resins and polyphenylene sulfide resins) are preferred because of their high wear resistance, high toughness, and high elastic coefficient.

Examples of the resin having a siloxane group include resins having a polysiloxane structure in their main or side chain. One resin having a siloxane group may be used alone, or a combination of two or more may be used.

Specific examples of the resin having a siloxane group include siloxane-modified polyimide resins, siloxane-modified polyamide-imide resins, thermosetting silicone resins, silicone oil gums, silicone elastomers, and siloxane-modified polyetherimides.

The thermosetting silicone resin is silicone resin particles that are cured by heat and have rubber-like elasticity. With the thermosetting silicone resin, the affinity for the lubricant tends to increase.

The silicone oil gum is a silicone oil having a molecular weight of 300000 or more and formed into pellets.

In particular, the resin having a siloxane group may be at least one of a siloxane-modified polyimide resin and a siloxane-modified polyamide-imide resin.

The resin having a siloxane group is preferably in the form of resin particles and more preferably thermosetting silicone resin particles. With these components, the affinity for the lubricant is particularly high. Therefore, both better slidability and a higher charge suppression ability are obtained.

The content of the resin having a siloxane group with respect to the heat-resistant thermoplastic resin is preferably 1.0% by mass or more and 20.0% by mass or less, more preferably 2.0% by mass or more and 15.0% by mass or less, and still more preferably 5.0% by mass or more and 10.0% by mass or less.

When the content of the resin having a siloxane group is within the above range, the affinity for the lubricant and the affinity for the inner circumferential surface of the second rotatable member become high, and better slidability and a higher charge suppression ability are obtained.

The conducting material treated with siloxane is a conducting material subjected to surface coating treatment with a siloxane compound such as a resin having a siloxane group (e.g., a silicone resin) or a silane-based coupling agent to impart siloxane groups to the surface. From the viewpoint of obtaining high stability during long-term use of the fixing device and obtaining good slidability and a high charge suppression ability, the conducting material treated with siloxane may be a conducting material subjected to surface coating treatment with a resin having a siloxane group to impart siloxane groups to the surface.

Examples of the silicone resin include methyl-based straight silicone resins (such as a dimethylsiloxane resin), methylphenyl-based straight silicone resins, acrylic resin-modified silicone resins, ester resin-modified silicone resins, epoxy resin-modified silicone resins, alkyd resin-modified silicone resins, and rubber-based silicone resins. In particular, the silicone resin is preferably a methyl-based straight silicone resin and more preferably a dimethylsiloxane resin.

Examples of the conducting material include: carbon black; metals such as aluminum and nickel; metal oxides such as yttrium oxide and tin oxide; ion conductive materials such as potassium titanate and potassium chloride; and electrically conductive polymers such as polyaniline, polypyrrole, polysulfone, and polyacetylene. In particular, from the viewpoint of increasing the affinity for the resin having a siloxane group to prevent the conducting material from coming off from the sliding surface to thereby further increase the charge suppression ability, the conducting material may be carbon black. Carbon black is preferred also because it has high electric conductivity and high electric conductivity can be imparted even when its content is small.

Examples of the carbon black include Ketjen black, oil furnace black, channel black, acetylene black, and carbon black with an oxidized surface (hereinafter referred to as “oxidation-treated carbon black”). Of these, oxidation-treated carbon black may be used from the viewpoint of stability of electric resistance over time.

The oxidation-treated carbon black is obtained by adding a carboxyl group, a quinone group, a lactone group, a hydroxyl group, etc. to the surface of carbon black. Examples of the surface treatment method include an air oxidation method in which carbon black is brought into contact with air in a high-temperature atmosphere to react therewith, a method in which carbon black is allowed to react with nitrogen oxide or ozone at room temperature (e.g., 22° C.), and a method in which carbon black is oxidized with air in a high-temperature atmosphere and then oxidized with ozone at low temperature.

The average primary particle diameter of the conducting material is preferably 5 nm or more and 50 nm or less, more preferably 10 nm or more and 30 nm or less, and particularly preferably 15 nm or more and 25 nm or less.

When the average primary particle diameter of the conducting material is 5 nm or more and 50 nm or less, the dispersibility of the conducting material in the sliding sheet 60 is sufficiently high, so that the surface smoothness against the second rotatable member may be improved.

The average primary particle diameter of the conducting material treated with siloxane in the sliding sheet 60 is measured by the following method.

First, a measurement sample with a thickness of 100 nm is cut from the sliding sheet 60 using a microtome. The measurement sample is observed under a TEM (transmission electron microscope). The diameters of circles having areas equal to the projected areas of 50 electrically conductive particles are used as their particle diameters, and their average value is used as the average primary particle diameter.

The content of the conducting material with respect to 100 parts by mass of the resin included in the layer forming the sliding surface of the sliding member (e.g., the sliding sheet 60) may be 5 parts by mass or more, preferably 5 parts by mass or more and 50 parts by mass or less, more preferably 5 parts by mass or more and 40 parts by mass or less, and still more preferably 5 parts by mass or more and 30 parts by mass or less.

When the content of the conducting material is 5 parts by mass or more, appropriate electrical conductivity is imparted, and a higher charge suppression ability is obtained. Moreover, the compatibility between the sliding surface of the sliding member, the inner circumferential surface of the second rotatable member, and the lubricant tends to increase, and better slidability is obtained. When the content of the conducting material is 50 parts by mass or less, the sliding member is not embrittled, and the conducting material is easily prevented from coming off, so that a higher charge suppression ability is obtained.

The resin base layer forming the sliding surface may contain an additional component other than the resin having a siloxane group and the conducting material treated with siloxane. Examples of the additional component include a conducting material, a filler for improving mechanical strength, an antioxidant for preventing thermal deterioration, a surfactant, and a heat resistant antioxidant.

### —Lubricant 62 (Example of Lubricant)—

The lubricant 62 contains an oil having a siloxane group in its main chain.

The oil having a siloxane group in its main chain is an oil having a polysiloxane structure in the main chain, and examples thereof include silicone oils and various modified silicone oils. When the lubricant 62 is an oil having a siloxane group in the main chain, the affinity for the inner circumferential surface of the pressing belt 40 tends to increase, so that the slidability with the pressing belt 40 becomes high.

Specific examples of the lubricant 62 include: modified oils such as alkyl-modified silicone oils (e.g., dimethyl-modified silicone oils), amino-modified silicone oils, methylphenyl-modified silicone oils, epoxy-modified silicone oils, phenol-modified silicone oils, polyether-modified silicone oils, and fluorine-modified silicone oils; and greases containing these oils (such as silicone greases).

In particular, from the viewpoint of increasing the affinity for the inner circumferential surface of the pressing belt 40 to further improve the slidability with the pressing belt 40, the lubricant 62 may contain at least one of dimethyl silicone oil and amino-modified silicone oil. The lubricant 62 may contain, in addition to the oil, additional components so long as the effects of the exemplary embodiment can be obtained. Examples of the additional components include a grease, a heat transfer agent, an antioxidant, a surfactant, silicone particles, an organic metal salt, and a hindered amine.

### (Image Forming Operations of Image Forming Apparatus)

The image forming operations of the image forming apparatus according to the exemplary embodiment will be described. The operation for forming a yellow image in the first process cartridge 10Y will be described as a representative image forming operation.

First, before the image forming operation, the charging roller 2Y charges the surface of the photoconductor 1Y to a potential of, for example, from about −600 V to about −800 V.

The photoconductor 1Y is formed, for example, by stacking a photosensitive layer on an electrically conductive base. The resistance of the photosensitive layer is generally high. One property of the photosensitive layer is that, when the photosensitive layer is irradiated with the laser beam 3Y, the specific resistance of the portion irradiated with the laser beam is changed. Therefore, the laser beam 3Y is outputted through the exposure device 3 onto the charged surface of the photoconductor 1Y according to yellow image data sent from an unillustrated controller. The photosensitive layer on the surface of the photoconductor 1Y is irradiated with the laser beam 3Y, and an electrostatic latent image having a yellow print pattern is thereby formed on the surface of the photoconductor 1Y.

The electrostatic latent image formed on the photoconductor 1Y as described above is rotated to a developing position as the photoconductor 1Y runs. The electrostatic latent image on the photoconductor 1Y is visualized at the developing position by the developing device 4Y (a toner image is formed).

The developing device 4Y houses a developer containing, for example, a yellow toner and a carrier. The yellow toner is agitated in the developing device 4Y and thereby frictionally charged. The charged yellow toner has a charge with the same polarity (negative polarity) as the charge on the photoconductor 1Y. As the surface of the photoconductor 1Y passes through the developing device 4Y, the yellow toner electrostatically adheres only to charge-eliminated latent image portions on the surface of the photoconductor 1Y, and the latent image is thereby developed with the yellow toner. Then the photoconductor 1Y with the yellow toner image formed thereon continues running, and the toner image developed on the photoconductor 1Y is transported to a first transfer position.

When the yellow toner image on the photoconductor 1Y is transported to the first transfer position, a first transfer bias is applied to the first transfer roller 5Y, and an electrostatic force directed from the photoconductor 1Y toward the first transfer roller 5Y acts on the toner image, so that the toner image on the photoconductor 1Y is transferred onto the intermediate transfer belt 20. The transfer bias applied in this case has a (+) polarity opposite to the (−) polarity of the toner and is controlled to, for example, about +10 μA in the first process cartridge 10Y by the controller (not shown).

The first transfer biases applied to the first transfer rollers 5M, 5C, and 5K of the second process cartridge 10M and subsequent process cartridges are controlled in the same manner as that for the first process cartridge.

The intermediate transfer belt 20 with the yellow toner image transferred thereon in the first process cartridge 10Y is sequentially transported through the second to fourth process cartridges 10M, 10C, and 10K, and toner images of respective colors are superimposed and multi-transferred.

Then the intermediate transfer belt 20 with all the color toner images multi-transferred thereon in the first to fourth process cartridges reaches a second transfer portion that is composed of the intermediate transfer belt 20, the support roller 24 in contact with the inner circumferential surface of the intermediate transfer belt 20, and a second transfer roller (an example of a second transferring device) 26 disposed on the image holding surface side of the intermediate transfer belt 20. A recording medium P is supplied to a gap between the secondary transfer roller 26 and the intermediate transfer belt 20 through a supply mechanism, and a second transfer bias is applied to the support roller 24. The transfer bias applied in this case has the same polarity (−) as the polarity (−) of the toner, and an electrostatic force directed from the intermediate transfer belt 20 toward the recording medium P acts on the toner image, so that the toner image on the intermediate transfer belt 20 is transferred onto the recording medium P. In this case, the second transfer bias is determined according to a resistance detected by resistance detection means (not shown) for detecting the resistance of the second transfer portion and is constant-voltage-controlled.

The intermediate transfer belt 20, the first transfer roller 5Y, and the second transfer roller 26 correspond to an example of the transfer device.

Then the recording medium P is fed to the fixing device 28 and inserted into a contact region in which the heating roller 30 rotated in the direction indicated by an arrow and the pressing belt 40 are in pressure contact with each other. In this case, the recording medium P is inserted such that the surface of the recording medium P on which the unfixed toner image has been formed and the surface of the heating roller 30 face each other. As the recording medium P passes through the contact region, heat and pressure are applied to the recording medium P, and the unfixed toner image is fixed to the recording medium P. The recording medium after the fixation passes through the contact region, then separated from the heating roller 30, and discharged from the fixing device 28.

The fixation processing is performed as described above, and the image is permanently fixed to the recording medium P. The recording medium P with the color image fixed thereon is transported to an ejection portion, and a series of the color image formation operations is thereby completed.

### EXAMPLES

Examples will next be described. However, the present disclosure is not at all limited to these Examples. In the following description, “parts” and “%” are based on mass, unless otherwise specified.

In Tables 1 to 3, the resin base layer is denoted simply as “base layer.”

The amount of the conducting material shown in Tables 1 to 3 is parts (i.e., parts by mass) with respect to 100 parts by mass of the resin in the resin base layer forming the inner circumferential surface of the pressing belt or with respect to 100 parts by mass of the resin in the layer forming the sliding surface of the sliding sheet (i.e., the resin in the sliding sheet).

### <Production of Pressing Belts>

### (Production of Pressing Belt (1))

The surface of an aluminum-made circular cylindrical core body with irregularities formed thereon by shot blasting is coated with a silicone-based release agent, and the coating is subjected to baking treatment at 300° C. for 1 hour. Then the resulting surface is dip-coated with an N-methylpyrrolidone solution containing a precursor of a siloxane-modified polyimide resin and a conducting material, i.e., carbon black treated with siloxane (dimethylsiloxane-treated product, SI-01 manufactured by DAITO KASEI KOGYO CO., LTD.), in an amount shown in Table 1, and the coating is dried at 100° C. for 1 hour. A resin base layer forming the inner circumferential surface of a pressing belt is thereby formed.

Next, the outer circumferential surface of the resin base layer is coated with a fluorocarbon resin dispersion (specifically, a PTFE dispersion), and the coating is dried at 60° C. for 10 minutes in a firing furnace, gradually heated to 380° C., fired for 20 minutes, and cooled to room temperature to thereby form a release layer.

Then the resin base layer with the release layer formed thereon is pulled out of the core body and cut to a desired size using a cutter to thereby obtain a pressing belt (1).

### (Production of Pressing Belt (2))

The surface of an aluminum-made circular cylindrical core body with irregularities formed thereon by shot blasting is coated with a silicone-based release agent, and the coating is subjected to baking treatment at 300° C. for 1 hour. Then the resulting surface is dip-coated with an N-methylpyrrolidone solution containing a precursor of a siloxane-modified polyamide-imide resin and a conducting material, i.e., carbon black treated with siloxane (dimethylsiloxane-treated product, SI-01 manufactured by DAITO KASEI KOGYO CO., LTD.), in an amount shown in Table 1, and the coating is dried at 100° C. for 1 hour. A resin base layer forming the inner circumferential surface of a pressing belt is thereby formed.

Next, the outer circumferential surface of the resin base layer is coated with a fluorocarbon resin dispersion (specifically, a PTFE dispersion), and the coating is dried at 60° C. for 10 minutes in a firing furnace, gradually heated to 380° C., fired for 20 minutes, and cooled to room temperature to thereby form a release layer.

Then the resin base layer with the release layer formed thereon is pulled out of the core body and cut to a desired size using a cutter to thereby obtain a pressing belt.

### (Production of Pressing Belt (3))

The surface of an aluminum-made circular cylindrical core body with irregularities formed thereon by shot blasting is coated with a silicone-based release agent, and the coating is subjected to baking treatment at 300° C. for 1 hour. Then the resulting surface is dip-coated with an N-methylpyrrolidone solution containing a precursor of a siloxane-modified polyimide resin and a conducting material, i.e., particles of aluminum oxide treated with siloxane, in an amount shown in Table 1, and the coating is dried at 100° C. for 1 hour. A resin base layer forming the inner circumferential surface of a pressing belt is thereby formed.

Next, the outer circumferential surface of the resin base layer is coated with a fluorocarbon resin dispersion (specifically, a PTFE dispersion), and the coating is dried at 60° C. for 10 minutes in a firing furnace, gradually heated to 380° C., fired for 20 minutes, and cooled to room temperature to thereby form a release layer.

Then the resin base layer with the release layer formed thereon is pulled out of the core body and cut to a desired size using a cutter to thereby obtain a pressing belt.

### (Production of Pressing Belts (4) to (5))

Pressing belts are obtained using the same procedure as for the pressing belt (1) except that the amount of the conducting material in the resin base layer is changed to an amount shown in Table 1.

### (Production of Pressing Belt (6))

A pressing belt is obtained using the same procedure as for the pressing belt (1) except that the amount of the conducting material in the method for producing the pressing belt (1) is changed to 6 parts by mass.

(Production of Pressing Belt (c1))

A pressing belt is obtained using the same procedure as for the pressing belt (1) except that the “N-methylpyrrolidone solution containing the precursor of the siloxane-modified polyamide-imide resin and the conducting material, i.e., carbon black treated with siloxane (dimethylsiloxane-treated product, SI-01 manufactured by DAITO KASEI KOGYO CO., LTD.),” in the method for producing the pressing belt (1) is changed to an “N-methylpyrrolidone solution containing only an unmodified polyimide resin precursor.”

### <Production of Sliding Sheets>

### (Production of Sliding Sheet (1))

A polyether ether ketone (PEEK) resin (Victrex 450G manufactured by Victrex) is heated to 380° C. and melted in a twin-screw extrusion melt kneader (twin-screw melt kneading extruder L/D60 (manufactured by PARKER CORPORATION)). 10 Parts by mass of thermosetting silicone resin particles (“KMP590” manufactured by Shin-Etsu Chemical Co., Ltd.) and 15 parts by mass of carbon black treated with siloxane (dimethylsiloxane-treated product, SI-01 manufactured by DAITO KASEI KOGYO CO., LTD.) are supplied to 100 parts by mass of the molten PEEK resin from a side portion of the kneader using a side feeder, and the mixture is melted and kneaded. The kneaded molten mixture is placed in a water bath to cool and solidify the mixture, and the resulting mixture is cut to a desired size to thereby obtain resin mixture pellets containing the silicone resin particles.

The obtained resin mixture pellets are fed to a single-screw extruder, and the molten resin mixture is extruded from a T die (melt discharge gap: 200 μm) heated to 380° C. into a sheet shape. The sheet is wound around a cooling roller at 190° C. to cool the sheet. Using a roller having a 100-mesh SUS metal net wound around the surface of the roller, the shape of the metal net is transferred to the cooled sheet at 250° C. under a pressure of 40 MPa to obtain a sheet having irregularities. The sheet having irregularities is cut into a prescribed size to thereby obtain a sliding sheet (1).

### (Production of Sliding Sheet (2))

A sliding sheet is obtained using the same procedure as that for the sliding sheet (1) except that unmodified thermosetting silicone resin particles (“R200” manufactured by Shin-Etsu Chemical Co., Ltd.) are used instead of the thermosetting silicone resin particles (“KMP590” manufactured by Shin-Etsu Chemical Co., Ltd.) used in the method for producing the sliding sheet (1).

### (Production of Sliding Sheet (3))

A sliding sheet is obtained using the same procedure as that for the sliding sheet (1) except that a conducting material, i.e., aluminum oxide particles treated with siloxane, in an amount shown in Table 1 is used instead of the carbon black treated with siloxane (dimethylsiloxane-treated product, SI-01 manufactured by DAITO KASEI KOGYO CO., LTD.) used in the method for producing the sliding sheet (1).

### (Production of Sliding Sheet (4))

A sliding sheet is obtained using the same procedure as that for the sliding sheet (1) except that the amount of the conducting material used in the method for producing the sliding sheet (1) is changed to 4 parts by mass.

### (Production of Sliding Sheets (5) to (6))

Sliding sheets are obtained using the same procedure as that for the sliding sheet (1) except that the amount of the conducting material used in the method for producing the sliding sheet (1) is changed to an amount shown in Table 1.

(Production of Sliding Sheet (c1))

A polytetrafluoroethylene (PTFE) resin sintered body is subjected to skiving (the resin is skived with a shape edge into a thin film) to a thickness of 200 μm, and a sliding sheet (c1) is thereby obtained.

(Production of Sliding Sheet (c2))

A polyimide resin is heated to 380° C. and melted in a twin-screw extrusion melt kneader (twin-screw melt kneading extruder L/D60 (manufactured by PARKER CORPORATION)). The molten polyimide resin is kneaded, and the kneaded molten product is placed in a water bath to cool and solidify the product. The resulting product is cut to a desired size to thereby obtain resin pellets containing the polyimide resin.

The obtained resin pellets are fed to a single-screw extruder, and the molten resin is extruded from a T die (melt discharge gap: 200 μm) heated to 380° C. into a sheet shape. The sheet is wound around a cooling roller at 190° C. to cool the sheet. Using a roller having a 100-mesh SUS metal net wound around the surface of the roller, the shape of the metal net is transferred to the cooled sheet at 250° C. under a pressure of 40 MPa to obtain a sheet having irregularities. The sheet having irregularities is cut into a prescribed size to thereby obtain a sliding sheet.

(Production of Sliding Sheet (c3))

A polyether ether ketone (PEEK) resin (Victrex 450G manufactured by Victrex) is heated to 380° C. and melted in a twin-screw extrusion melt kneader (twin-screw melt kneading extruder L/D60 (manufactured by PARKER CORPORATION)). 20 Parts by mass of particles of a resin having a siloxane group (product name: KMP590 manufactured by Shin-Etsu Chemical Co., Ltd.) shown in Table 3 and untreated carbon black (acetylene black manufactured by DENKI KAGAKU KOGYO KABUSHIKI KAISHA) are supplied to 100 parts by mass of the molten PEEK resin from a side portion of the kneader using a side feeder, and the mixture is melted and kneaded. The kneaded molten mixture is placed in a water bath to cool and solidify the mixture, and the resulting mixture is cut to a desired size to thereby obtain resin mixture pellets containing the silicone resin particles.

The obtained resin mixture pellets are fed to a single-screw extruder, and the molten resin mixture is extruded from a T die (melt discharge gap: 200 μm) heated to 380° C. into a sheet shape. The sheet is wound around a cooling roller at 190° C. to cool the sheet. Using a roller having a 100-mesh SUS metal net wound around the surface of the roller, the shape of the metal net is transferred to the cooled sheet at 250° C. under a pressure of 40 MPa to obtain a sheet having irregularities. The sheet having irregularities is cut into a prescribed size to thereby obtain a sliding sheet (c3).

### <Lubricant>

Lubricant (1): dimethyl silicone oil (product name: “KF96” manufactured by Shin-Etsu Chemical Co., Ltd.)
Lubricant (2): amino-modified silicone oil (product name “KF8009” manufactured by Shin-Etsu Chemical Co., Ltd.)
Lubricant (3): dimethyl silicone oil-containing silicone grease (“G503” manufactured by Shin-Etsu Chemical Co., Ltd.)

### Examples 1 to 10 and Comparative Examples 1 to 3

The pressing belts, the sliding sheets, and the lubricants are combined as shown in Tables 1 to 3, and one of the combinations is attached to a fixing device of an image forming apparatus obtained by modifying “APEOS PORT Print C5570” manufactured by FUJIFILM Business Innovation Corp.

Each apparatus is used as an image forming apparatus in the corresponding Example, and the following evaluation is performed.

### <Evaluation of Paper Wrinkling>

A solid image (solid blue image, density: 100%) is continuously outputted onto A4 paper sheets (1000 kPV). The evaluation is performed based on the cumulative number of outputted sheets when paper wrinkling occurs due to a reduction in slidability according to the following evaluation criteria.
A: No paper deformation and no paper wrinkling occur even after the cumulative number of sheets reaches 300000.
B: The cumulative number of sheets when paper wrinkling occurs is 200000 or more and less than 300000.
C: The cumulative number of sheets when paper wrinkling occurs is 100000 or more and less than 200000.
D: The cumulative number of sheets when paper wrinkling occurs is 50000 or more and less than 100000.
E: The cumulative number of sheets when paper wrinkling occurs is less than 50000.

### <Evaluation of Charge Suppression Ability>

The image forming apparatus is left to stand in an environment of 10° C. and 5% RH for 24 hours, and a solid image is continuously outputted onto A4 paper sheets. The charge suppression ability is evaluated based on density unevenness in the solid image that occurs when the chargeability increases according to the following evaluation criteria using the cumulative number of outputted sheets.
A: No image density unevenness occurs even after the cumulative number of sheets reaches 300000.
B: The cumulative number of sheets when image density unevenness occurs is 200000 or more and less than 300000.
C: The cumulative number of sheets when image density unevenness occurs is 100000 or more and less than 200000.
D: The cumulative number of sheets when image density unevenness occurs is 50000 or more and less than 100000.
E: The cumulative number of sheets when image density unevenness occurs is less than 50000.

TABLE 1

| | | Example | | | | | |
|---|---|---|---|---|---|---|---|
| | | 1 | 2 | 3 | 4 | 5 | 6 |
| Base layer | Type of pressing | (1) | (4) | (5) | (1) | (2) | (3) |
| of | belt | | | | | | |
| pressing | Type of resin | Siloxane- | Siloxane- | Siloxane- | polyimide | Siloxane- | polyimide |
| belt | | modified | modified | modified | Siloxane- | modified | Siloxane- |
| | | polyimide | polyimide | polyimide | modified | polyamide- | modified |
| | | resin | resin | resin | resin | imide resin | resin |
| | Type of conducting | Siloxane- | Siloxane- | Siloxane- | Siloxane- | Siloxane- | Siloxane- |
| | material | treated | treated | treated | treated | treated | treated |
| | | carbon | carbon | carbon | carbon | carbon | aluminum |
| | | black | black | black | black | black | oxide |
| | Surface resistivity | 3.2 × 10⁵ | 1.1 × 10⁶ | 2.1 × 10⁴ | 3.2 × 10⁵ | 4.3 × 10⁵ | 3.1 × 10⁵ |
| | of inner | | | | | | |
| | circumferential | | | | | | |
| | surface [Ω/square] | | | | | | |
| | Amount of | 15 parts | 10 parts | 20 parts | 15 parts | 15 parts by | 25 parts |
| | conducting material | by mass | by mass | by mass | by mass | mass | by mass |
| | with respect to 100 | | | | | | |
| | parts by mass of | | | | | | |
| | resin in base layer | | | | | | |
| Sliding | Type of sliding | (1) | (5) | (6) | (1) | (1) | (1) |
| sheet | sheet | | | | | | |
| | Type of resin | Silicone | Silicone | Silicone | Silicone | Silicone | Silicone |
| | | resin | resin | resin | resin | resin | resin |
| | Type of conducting | Siloxane- | Siloxane- | Siloxane- | Siloxane- | Siloxane- | Siloxane- |
| | material | treated | treated | treated | treated | treated | treated |
| | | carbon | carbon | carbon | carbon | carbon | carbon |
| | | black | black | black | black | black | black |
| | Amount of | 15 parts | 10 parts | 20 parts | 15 parts | 15 parts by | 15 parts |
| | conducting material | by mass | by mass | by mass | by mass | mass | by mass |
| | with respect to 100 | | | | | | |
| | parts by mass of | | | | | | |
| | resin | | | | | | |
| | Surface resistivity | 3.2 × 10⁵ | 2.1 × 10⁶ | 1.1 × 10⁴ | 3.2 × 10⁵ | 3.2 × 10⁵ | 3.2 × 10⁵ |
| | of sliding surface | | | | | | |
| | [Ω/square] | | | | | | |
| Lubricant | Type of lubricant | (1) | (2) | (1) | (3) | (1) | (1) |
| | Material of | Silicone | Silicone | Silicone | Silicone | Silicone | Silicone |
| | lubricant | oil | oil | oil | grease | oil | oil |
| Evaluation | Paper wrinkling | A | A | A | C | C | A |
| | (1000 kPV) | | | | | | |
| | Charge suppression | A | B | A | B | B | B |
| | ability | | | | | | |

TABLE 2

| | | Example | | | |
|---|---|---|---|---|---|
| | | 7 | 8 | 9 | 10 |
| Base layer | Type of pressing belt | (1) | (1) | (6) | (1) |
| of | Type of resin | Siloxane- | Siloxane- | Siloxane- | Siloxane- |
| pressing | | modified | modified | modified | modified |
| belt | | polyimide | polyimide | polyimide | polyimide |
| | | resin | resin | resin | resin |
| | Type of conducting | Siloxane- | Siloxane- | Siloxane- | Siloxane- |
| | material | treated carbon | treated carbon | treated carbon | treated carbon |
| | | black | black | black | black |
| | Surface resistivity of | 3.2 × 10⁵ | 3.2 × 10⁵ | 6.1 × 10⁸ | 3.2 × 10⁵ |
| | inner circumferential | | | | |
| | surface [Ω/square] | | | | |
| | Amount of | 15 parts by | 15 parts by | 6 parts by | 15 parts by |
| | conducting material | mass | mass | mass | mass |
| | with respect to 100 | | | | |
| | parts by mass of | | | | |
| | resin in base layer | | | | |
| Sliding | Type of sliding sheet | (2) | (3) | (1) | (4) |
| sheet | Type of resin | Unmodified | Silicone resin | Silicone resin | Silicone resin |
| | | silicone resin | | | |
| | | particles | | | |
| | Type of conducting | Siloxane- | Siloxane- | Siloxane- | Siloxane- |
| | material | treated carbon | treated | treated carbon | treated carbon |
| | | black | aluminum | black | black |
| | | | oxide | | |
| | Amount of | 20 parts by | 15 parts by | 15 parts by | 4 parts by |
| | conducting material | mass | mass | mass | mass |
| | with respect to 100 | | | | |
| | parts by mass of | | | | |
| | resin | | | | |
| | Surface resistivity of | 1.8 × 10⁴ | 1.1 × 10⁶ | 3.2 × 10⁵ | 7.5 × 10⁹ |
| | sliding surface | | | | |
| | [Ω/square] | | | | |
| Lubricant | Type of lubricant | (1) | (1) | (1) | (1) |
| | Material of lubricant | Silicone oil | Silicone oil | Silicone oil | Silicone oil |
| Evaluation | Paper wrinkling | B | B | C | D |
| | (1000 kPV) | | | | |
| | Charge suppression | A | C | D | D |
| | ability | | | | |

TABLE 3

| | | Comparative Example | | |
|---|---|---|---|---|
| | | 1 | 2 | 3 |
| Base layer | Type of pressing belt | (c1) | (c1) | (1) |
| of | Type of resin | Polyimide resin | Polyimide resin | Siloxane- |
| pressing | | | | modified |
| belt | | | | polyimide resin |
| | Type of conducting | NA | NA | Siloxane-treated |
| | material | | | carbon black |
| | Surface resistivity of inner | NA | NA | 3.2 × 10⁵ |
| | circumferential surface | | | |
| | [Ω/square] | | | |
| | Amount of conducting | 0 | 0 | 20 parts by mass |
| | material with respect to | | | |
| | 100 parts by mass of resin | | | |
| | in base layer | | | |
| Sliding | Type of sliding sheet | (c1) | (c2) | (c3) |
| sheet | Type of resin | Fluorocarbon | Polyimide resin | Silicone resin |
| | | resin (PTFE) | | |
| | Type of conducting | NA | NA | Untreated |
| | material | | | acetylene black |
| | Amount of conducting | 0 | 0 | 20 parts by mass |
| | material with respect to | | | |
| | 100 parts by mass of resin | | | |
| | Surface resistivity of | NA | NA | 8.8 × 10⁵ |
| | sliding surface [Ω/square] | | | |
| Lubricant | Type of lubricant | (1) | (1) | (1) |
| | Material of lubricant | Silicone oil | Silicone oil | Silicone oil |
| Evaluation | Paper wrinkling | E | E | E |
| | (1000 kPV) | | | |
| | Charge suppression ability | E | E | E |

As can be seen from the above results, in the image forming apparatuses in the Examples, the occurrence of paper wrinkling is reduced as compared with that in the image forming apparatuses in the Comparative Examples, and image density unevenness is also reduced. Specifically, the image forming apparatuses in the Examples have better slidability and higher charge suppression ability than the image forming apparatuses in the Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A fixing device including:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member;
a sliding member interposed between the inner circumferential surface of the second rotatable member and the pressing member; and
a lubricant interposed between the inner circumferential surface of the second rotatable member and the sliding member,
wherein the inner circumferential surface of the second rotatable member contains a resin having a siloxane group and a conducting material treated with siloxane,
wherein a sliding surface of the sliding member contains a resin having a siloxane group and a conducting material treated with siloxane, and
wherein the lubricant contains an oil having a siloxane group in a main chain.

(((2))) The fixing device according to (((1))), wherein the conducting material contained in the inner circumferential surface of the second rotatable member and/or the conducting material contained in the sliding surface of the sliding member is carbon black.

(((3))) The fixing device according to (((1))) or (((2))), wherein the content of the conducting material contained in a layer forming the inner circumferential surface of the second rotatable member with respect to 100 parts by mass of a resin contained in the layer forming the inner circumferential surface of the second rotatable member is 5 parts by mass or more.

(((4))) The fixing device according to (((3))), wherein the content of the conducting material contained in the layer forming the inner circumferential surface of the second rotatable member with respect to 100 parts by mass of the resin contained in the layer forming the inner circumferential surface of the second rotatable member is 10 parts by mass or more and 50 parts by mass or less.

(((5))) The fixing device according to any one of (((1))) to (((4))), wherein the resin having a siloxane group and contained in the inner circumferential surface of the second rotatable member and/or the resin having a siloxane group and contained in the sliding surface of the sliding member is at least one of a siloxane-modified polyimide resin and a siloxane-modified polyamide-imide resin.

(((6))) The fixing device according to any one of (((1))) to (((5))), wherein the inner circumferential surface of the second rotatable member has a surface resistivity of 1.0×10⁷ Ω/square or less.

(((7))) The fixing device according to any one of (((1))) to (6))), wherein the sliding surface of the sliding member has a surface resistivity of 1.0×10⁷ Ω/square or less.

(((8))) The fixing device according to any one of (((1))) to (((7))), wherein the resin having a siloxane group and contained in the inner circumferential surface of the second rotatable member and/or the resin having a siloxane group and contained in the sliding surface of the sliding member is resin particles.

(((9))) The fixing device according to (((8))), wherein the sliding surface of the sliding member contains a heat-resistant thermoplastic resin, the resin particles of the resin having a siloxane group, and the conducting material treated with siloxane.

(((10))) The fixing device according to (((9))), wherein the resin particles are thermosetting silicone resin particles.

(((11))) The fixing device according to (((8))), wherein the inner circumferential surface of the second rotatable member contains the resin particles of the resin having a siloxane group, the conducting material treated with siloxane, and at least one resin selected from the group consisting of a polyimide resin, a polyamide-imide resin, a polyether ether ketone resin, and a polyphenylene sulfide resin.

(((12))) The fixing device according to (((11))), wherein the resin particles are thermosetting silicone resin particles.

(((13))) An image forming apparatus including:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to any one of (((1))) to (((12))), the fixing device fixing the toner image to the recording medium.

What is claimed is:

1. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member;
a sliding member interposed between the inner circumferential surface of the second rotatable member and the pressing member; and
a lubricant interposed between the inner circumferential surface of the second rotatable member and the sliding member,
wherein the inner circumferential surface of the second rotatable member contains a resin having a siloxane group and a conducting material treated with siloxane,
wherein a sliding surface of the sliding member contains a resin having a siloxane group and a conducting material treated with siloxane, and
wherein the lubricant contains an oil having a siloxane group in a main chain.

2. The fixing device according to claim 1, wherein the conducting material contained in the inner circumferential surface of the second rotatable member and/or the conducting material contained in the sliding surface of the sliding member is carbon black.

3. The fixing device according to claim 1, wherein the content of the conducting material contained in a layer forming the inner circumferential surface of the second rotatable member with respect to 100 parts by mass of a resin contained in the layer forming the inner circumferential surface of the second rotatable member is 5 parts by mass or more.

4. The fixing device according to claim 3, wherein the content of the conducting material contained in the layer forming the inner circumferential surface of the second rotatable member with respect to 100 parts by mass of the resin contained in the layer forming the inner circumferential surface of the second rotatable member is 10 parts by mass or more and 50 parts by mass or less.

5. The fixing device according to claim 1, wherein the resin having a siloxane group and contained in the inner circumferential surface of the second rotatable member and/or the resin having a siloxane group and contained in the sliding surface of the sliding member is at least one of a siloxane-modified polyimide resin and a siloxane-modified polyamide-imide resin.

6. The fixing device according to claim 1, wherein the inner circumferential surface of the second rotatable member has a surface resistivity of 1.0×10⁷ Ω/square or less.

7. The fixing device according to claim 1, wherein the sliding surface of the sliding member has a surface resistivity of 1.0×10⁷ Ω/square or less.

8. The fixing device according to claim 1, wherein the resin having a siloxane group and contained in the inner circumferential surface of the second rotatable member and/or the resin having a siloxane group and contained in the sliding surface of the sliding member is resin particles.

9. The fixing device according to claim 8, wherein the sliding surface of the sliding member contains a heat-resistant thermoplastic resin, the resin particles of the resin having a siloxane group, and the conducting material treated with siloxane.

10. The fixing device according to claim 9, wherein the resin particles are thermosetting silicone resin particles.

11. The fixing device according to claim 8, wherein the inner circumferential surface of the second rotatable member contains the resin particles of the resin having a siloxane group, the conducting material treated with siloxane, and at least one resin selected from the group consisting of a polyimide resin, a polyamide-imide resin, a polyether ether ketone resin, and a polyphenylene sulfide resin.

12. The fixing device according to claim 11, wherein the resin particles are thermosetting silicone resin particles.

13. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 1, the fixing device fixing the toner image to the recording medium.

14. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 2, the fixing device fixing the toner image to the recording medium.

15. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 3, the fixing device fixing the toner image to the recording medium.

16. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 4, the fixing device fixing the toner image to the recording medium.

17. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 5, the fixing device fixing the toner image to the recording medium.

18. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 6, the fixing device fixing the toner image to the recording medium.

19. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 7, the fixing device fixing the toner image to the recording medium.

20. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 8, the fixing device fixing the toner image to the recording medium.
